(19) United States
(12) Patent Application Publication
(10) Pub. No.: US 2011/0151858 A1
(43) Pub. Date: Jun. 23, 2011

(54) WIRELESS COMMUNICATION DEVICE

(75) Inventor: HOU-WEN LAI, Shenzhen City (CN)

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/820,042

(22) Filed: Jun. 21, 2010

(30) Foreign Application Priority Data
Dec. 17, 2009 (CN) 200910311700.1

(51) Int. Cl. H04W 40/00; G06F 3/00; G06F 13/00

(52) U.S. Cl. 455/422.1; 710/11; 710/301

(57) ABSTRACT

A wireless communication device includes a first protocol modem, a second protocol modem, a control module, a switch circuit, a first card slot, and a second card slot. One smart card may be inserted in the first card slot or the second card slot, and furthermore two smart cards may be inserted in the first card slot and the second card slot simultaneously. The wireless communication device may work in a first protocol network and a second protocol network with optional insertion of the smart card.

### BACKGROUND

1. Technical Field

The present disclosure relates to a wireless communication device with two smart card slots.

2. Description of Related Art

Many currently used dual mode mobile phones utilize a code division multiple access (CDMA) modem, a Global System for Mobile communications (GSM) modem, and two corresponding card slots. One card slot electronically connected with the CDMA modem is compatible for CDMA protocol. Alternatively, another card slot electronically connected with the GSM modem is compatible for GSM protocol. The dual mode mobile phone accepts only smart cards specifically compatible with the respective protocols in each corresponding slot.

### BRIEF DESCRIPTION OF THE DRAWINGS

FIG. 1 is a block diagram of one embodiment of a wireless communication device of the present disclosure.

FIG. 2 is a block diagram of one embodiment of a switch circuit shown in FIG. 1.

FIG. 3 is a flowchart illustrating one embodiment of a method for registering a wireless communication device in network.

### DETAILED DESCRIPTION

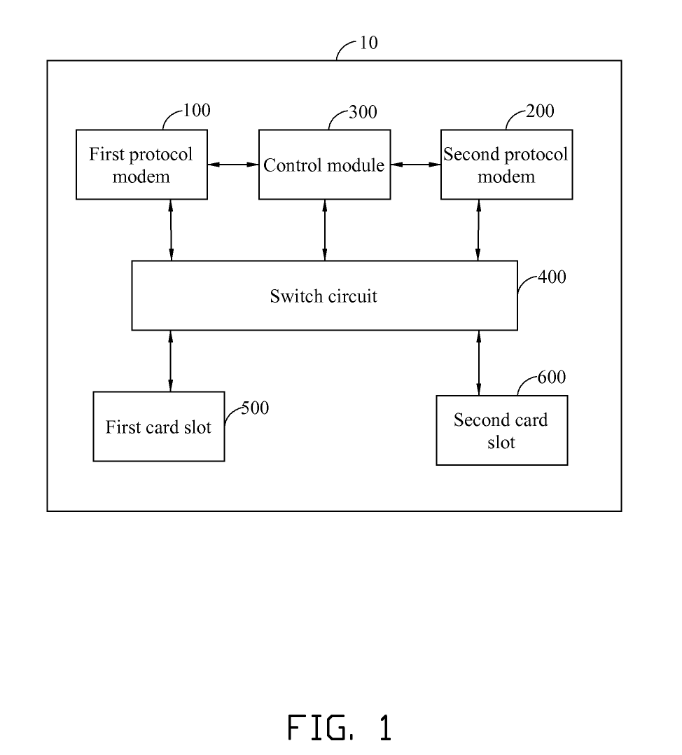

FIG. 1 is a block diagram of one embodiment of a wireless communication device 10 of the present disclosure. The wireless communication device 10 may work in a first protocol network and a second protocol network simultaneously. The wireless communication device 10 includes a first protocol modem 100, a second protocol modem 200, a control module 300, a switch circuit 400, a first card slot 500, and a second card slot 600. One smart card (not shown) can be inserted optionally in either the first card slot 500 or the second card slot 600, and two smart cards can both be inserted in the first card slot 500 and the second card slot 600 optionally. The present disclosure has the wireless communication device 10 working in a first protocol network and a second protocol network with optional insertion of the smart cards.

The first protocol modem 100 is operable to register the wireless communication device 10 in the first protocol network so that the wireless communication device 10 may work in the first protocol network. The second protocol modem 200 is operable to register the wireless communication device 10 in the second protocol network so that the wireless communication device 10 may work in the second protocol network. In the embodiment, the first protocol is code division multiple access (CDMA) and the second protocol is Global System for Mobile communications (GSM). The smart card may store a first protocol application or a second protocol application. The first protocol application is operable to identify that whether the smart card is compatible for the first protocol network. The second protocol application is operable to identify that whether the smart card is compatible for the second protocol network. In the embodiment, the first protocol application is a CDMA application and the second protocol application is a GSM application.

The control module 300 is operable to transmit a selection command to the switch circuit 400 to instruct the first protocol modem 100 to select the smart card. The first protocol modem 100 selects the first protocol application from the smart card upon the selection command. If the first protocol application is successfully selected, the first protocol modem 100 then registers the wireless communication device 10 in the first protocol network.

If the smart card does not store a first protocol application, the first protocol application is not successfully selected. As a result, the first protocol modem 100 transmits a failure signal to the control module 300. The control module 300 then transmits the selection command to the switch circuit 400 to instruct the second protocol modem 200 to select the smart card. The second protocol modem 200 selects the second protocol application from the smart card, and then registers the wireless communication device 10 in the second protocol network upon receipt of the selection command.

The switch circuit 400 is operable to electronically connect the first protocol modem 100 and the second protocol modem 200 with the first card slot 500 and the second card slot 600.

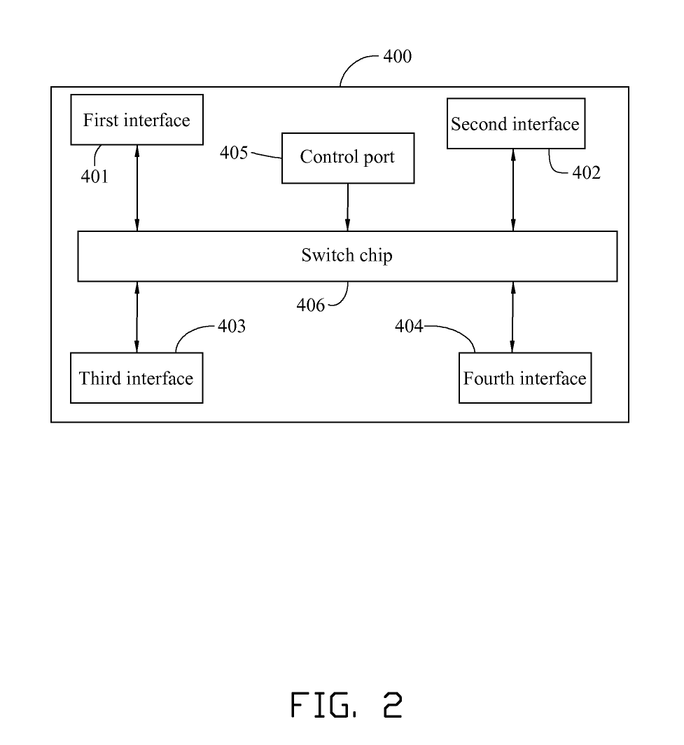

FIG. 2 is a block diagram of one embodiment of the switch circuit 400 shown in FIG. 1. The switch circuit 400 includes a first interface 401, a second interface 402, a third interface 403, a fourth interface 404, a control port 405, and a switch chip 406.

The first interface 401 is operable to electronically connect with the first protocol modem 100 and the switch chip 406. The second interface 402 is operable to electronically connect with the second protocol modem 200 and the switch chip 406.

The third interface 403 is operable to electronically connect with the first card slot 500 and the switch chip 406. The fourth interface 404 is operable to electronically connect with the second card slot 600 and the switch chip 406. The control port 405 is operable to receive the selection command from the control module 300 and transmit the selection command to the switch chip 406.

The switch chip 406 is operable to electronically connect two of the four interfaces upon the selection command. Particularly, the first interface 401 electronically connects with the third interface 403, the first interface 401 electronically connects with the fourth interface 404, the second interface 402 electronically connects with the third interface 403, and the second interface 402 electronically connects with the fourth interface 404.

The first protocol modem 100 and the second protocol modem 200 electronically connect with the smart card in the first card slot 500 or the second card slot 600 through the switch circuit 400. Simultaneously, the switch circuit 40 merely allows the first protocol modem 100 or the second protocol modem 200 to electronically connect with the smart card in the first card slot 500 or the second card slot 600.

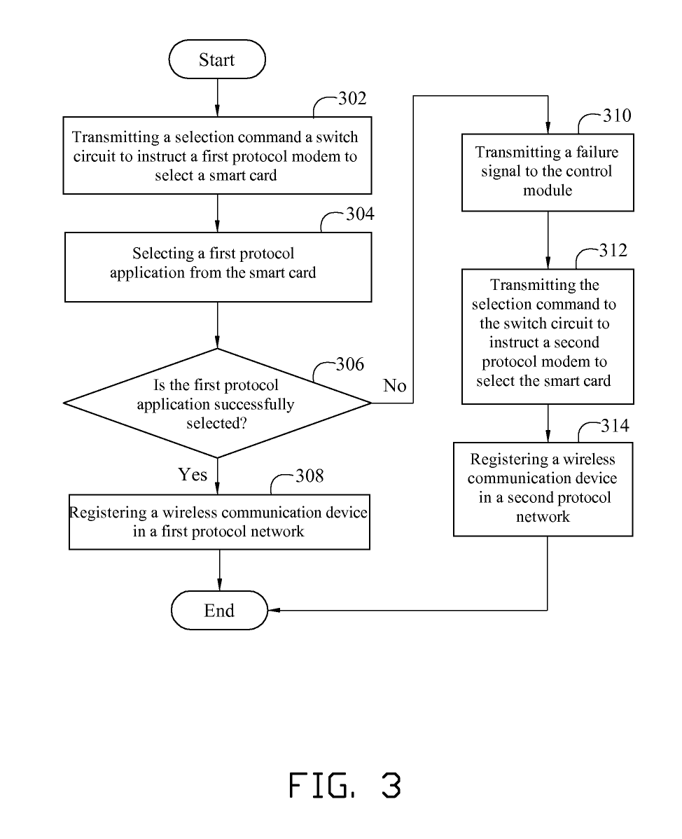

FIG. 3 is a flowchart illustrating of one embodiment of a method for registering the wireless communication device 10 in a network. Depending on the embodiment, additional blocks in the flow of FIG. 3 may be added, others removed, and the ordering of the blocks may be changed.

In block S302, the control module 300 transmits the selection command to the switch circuit 400 to instruct the first protocol modem 100 to select the smart card in the first card slot 500 or the second card slot 600.

In block S304, the first protocol modem 100 selects the first protocol application from the smart card.

In block S306, the first protocol modem 100 determines whether the first protocol application is successfully selected.

In block S308, if the first protocol application is successfully selected, the first protocol modem 100 registers the wireless communication device 10 in the first protocol network.

In block S310, if the first protocol application is not successfully selected, the first protocol modem 100 determines that the smart card is compatible for the second protocol network and transmits the failure signal to the control module 300.

In block S312, the control module 300 transmits the selection command to the switch circuit 400 to instruct the second protocol modem 200 to select the smart card.

In block S314, the second protocol modem 200 selects the second protocol application from the smart card, and then registers the wireless communication device 10 in the second protocol network.

The present disclosure provides a wireless communication device with two card slots, which may work in a first protocol network and a second protocol network through optional insertion of the smart card. The user experience is improved.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for registering a wireless communication device in a first protocol network and a second protocol network, the wireless communication device comprising a first card slot, a second card slot, at least one smart card received in the first card slot or the second card slot, a switch circuit, a first protocol modem, and a second protocol modem, the method comprising:
transmitting a selection command to the switch circuit to instruct the first protocol modem to select the smart card;
selecting a first protocol application from the smart card;
determining whether the first protocol application is successfully selected;
determining that the smart card is only compatible for the second protocol network if the first protocol application is not successfully selected;
transmitting the selection command to the switch circuit to instruct the second protocol modem to select the smart card;
selecting a second protocol application from the smart card; and
registering the wireless communication device in the second protocol network.

2. The method of claim 1, further comprising :
registering the wireless communication device in the first protocol network if the first protocol application is successfully selected.

3. The method of claim 2, wherein the switch circuit comprises a first interface, a second interface, a third interface, a fourth interface, and a switch chip.

4. The method of claim 3, wherein
the first interface is operable to electronically connect with the first protocol modem and the switch chip; and
the second interface is operable to electronically connect with the second protocol modem and the switch chip.

5. The method of claim 4, wherein
the third interface is operable to electronically connect with the first card slot and the switch chip; and
the fourth interface is operable to electronically connect with the second card slot and the switch chip.

6. The method of claim 5, wherein the first protocol is code division multiple access (CDMA) and the second protocol is Global System for Mobile communications (GSM).

7. A wireless communication device, comprising:
a first card slot and a second card slot;
a first protocol modem operable to select a first protocol application from a smart card received in the first card slot or the second card slot and register the wireless communication device in the first protocol network;
a second protocol modem operable to select a second protocol application from the smart card and register the wireless communication device in a second protocol network;
a switch circuit operable to electronically connect the first protocol modem and the second protocol modem with the first card slot and the second card slot; and
a control module operable to
transmit a selection command to the switch circuit to instruct the first protocol modem to select the smart card; and
transmit the selection command to the switch circuit to instruct the second protocol modem to select the smart card.

8. The wireless communication of claim 7, wherein the switch circuit comprises a first interface, a second interface, a third interface, a fourth interface, a switch chip, and a control port.

9. The wireless communication device of claim 8, wherein the first interface comprises is operable to electronically connect with the first protocol modem and the switch chip;
the second interface is operable to electronically connect with the second protocol modem and the switch chip;
the third interface is operable to electronically connect with the first card slot and the switch chip; and
the fourth interface is operable to electronically connect with the second card slot and the switch chip.

10. The wireless communication device of claim 9, wherein the control port is operable to receive the selection command from the control module and transmit the selection command to the switch chip.

11. The wireless communication device of claim 10, wherein the switch chip is operable to electronically connect the first interface and the second interface with the third interface and the fourth interface.

12. The wireless communication device of claim 11, wherein the first protocol is code division multiple access (CDMA) and the second protocol is Global System for Mobile communications (GSM).

13. A storage medium having stored thereon instructions that, when executed by a processor, causing the processor to perform a method for registering a wireless communication device in a first protocol network and a second protocol network, the wireless communication device comprising a first card slot, a second card slot, at least one smart card received in the first card slot or the second card slot, a switch circuit, a first protocol modem, and a second protocol modem, wherein the method comprises:
transmit a selection command to the switch circuit to instruct the first protocol modem to select the smart card;
select a first protocol application from the smart card;
determine whether the first protocol application is successfully selected;
determine that the smart card is only compatible for the second protocol network if the first protocol application is not successfully selected;
transmit the selection command to the switch circuit to instruct the second protocol modem to select the smart card;
select a second protocol application from the smart card; and
registering the wireless communication device in the second protocol network.

14. The storage medium of claim 13, wherein the method further comprises:
register the wireless communication device in the first protocol network if the first protocol application is successfully selected.

15. The storage medium of claim 14, wherein the switch circuit comprises a first interface, a second interface, a third interface, a fourth interface, and a switch chip.

16. The storage medium of claim 15, wherein
the first interface is operable to electronically connect with the first protocol modem and the switch chip ; and
the second interface is operable to electronically connect with the second protocol modem and the switch chip.

17. The storage medium of claim 16, wherein
the third interface is operable to electronically connect with the first card slot and the switch chip; and
the fourth interface is operable to electronically connect with the second card slot and the switch chip.

18. The storage medium of claim 17, wherein the first protocol is code division multiple access (CDMA) and the second protocol is Global System for Mobile communications (GSM).
